(19) United States
(12) Patent Application Publication
(10) Pub. No.: US 2024/0333097 A1
(43) Pub. Date: Oct. 3, 2024

(54) ELECTRIC MOTOR WITH AN ENERGY-HARVESTING DEVICE

(71) Applicant: voestalpine Automotive Components Dettingen GmbH & Co. KG, Dettingen an der Erms (DE)

(72) Inventors: Heinrich BURSY, Erkenbrechtsweiler (DE); Ulrich AMMANN, Filderstadt (DE); Christoph CHESHIRE, Stuttgart (DE); Stanislav PIRIIENKO, Göppingen (DE); Georg SCHMIDT, Laichingen (DE)

(21) Appl. No.: 18/293,182

(22) PCT Filed: Jul. 29, 2022
(86) PCT No.: PCT/EP2022/071471

§ 371 Date: Jan. 29, 2024

(30) Foreign Application Priority Data
Jul. 30, 2021 (EP) 21188965.4

(51) Int. Cl. H02K 7/20; H02K 11/25; H02K 11/35; H02K 11/40; H02K 21/14

(52) U.S. Cl. CPC H02K 7/20; H02K 11/25; H02K 11/35; H02K 11/40; H02K 21/14

(57) ABSTRACT

An electric motor, more particularly a permanent magnet-excited synchronous motor, is disclosed. In order to draw sufficient energy from a stator winding of a stator of the electric motor and also in order to be able to detect reliable measurement data from a rotor of the electric motor, it is proposed for the energy-harvesting device and the measuring device to be provided on the rotor, wherein the energy-harvesting device has at least one electrode for drawing electrical energy from an electrical field that forms as a counter electrode between this electrode and an end turn, which electrode extends in a circumference direction of the rotor and is positioned next to an end surface of the rotor.

### TECHNICAL FIELD

The invention relates to an electric motor, more particularly a permanent magnet-excited synchronous motor, having a stator that has a stator winding for producing a rotating stator field, wherein said electrical stator winding has at least one end turn, having a rotor, having an energy-harvesting device that is embodied to draw energy from the end turn of the stator winding, and having a measuring device that is connected to the energy-harvesting device in order to be supplied with electrical energy.

### PRIOR ART

WO2010/136052A1 has disclosed drawing, i.e. “harvesting”, magnetic energy from an end turn of a stator of an electric motor in order to provide electric power to a measuring device, for example for temperature measurement. The energy-harvesting device, which is used for the energy harvesting, and the measuring device are positioned on a stationary part of the electric motor, namely its end plate. This positioning, however, disadvantageously does not permit exact measurement data acquisition from rotating parts of the electric motor, for example from the rotor, or requires a comparatively high technical complexity in order to be achieved.

### SUMMARY OF THE INVENTION

The object of the invention, therefore, is to modify the design of an electric motor of the type described at the beginning in such a way that an exact measurement data acquisition at the rotor with a self-sufficient energy supply is possible.

The fact that the energy-harvesting device and the measuring device are provided on the rotor offers the possibility of acquiring measurement data such as physical values directly on the rotor of the electric motor. In order to be able to ensure a sufficient electrical energy supply despite the fact that the rotor rotates synchronously along with the rotating field, the energy-harvesting device has at least one electrode for drawing electrical energy from an electrical field that forms as a counter electrode between this electrode and the end turn, which electrode extends in the circumference direction of the rotor and is positioned next to the end surface of the rotor. It is thus possible to provide a sufficient output of electric energy to the energy-harvesting device in order to thus be able to reliably provide electric power to electric devices on the rotor. This is more particularly advantageous in the case of a permanent magnet-excited synchronous motor in which there are no rotor windings on the rotor available for an independent excitation. An exact self-sufficient measurement data acquisition of rotor-specific measured variables such as the temperature is enabled in this way.

Preferably, the electrode is formed by a conductor. For example, the conductor extends in a ribbon shape.

In order to ensure comparatively high electrical field strength between the electrode and the counter electrode or end turn and to minimize the distance between these, it is possible for the electrode to be provided so that it protrudes radially from the rotor.

A compact size can be achieved if the rotor has a rotor yoke and a conductor support, more particularly an electrically insulating conductor support, which is fastened to the rotor yoke and supports the electrode.

The conductor support preferably has a section that is embodied in the form of a circular ring in cross-section on which the electrode is provided, which can further simplify the design. For this purpose, the section is preferably embodied in the form of a hollow cylinder.

The design of the energy-harvesting device can be further simplified if the conductor support consists of plastic onto which the electrode is printed.

The first electrode is provided on an outside of the conductor support in order to minimize the distance between the electrode and the counter electrode. It is thus possible to produce a comparatively powerful electrical field in order to enable the energy-harvesting device to draw a sufficient amount of electrical power. The second electrode can be positioned on an inside of the conductor support in order to protect it from damage.

If the electrode provided on the conductor support is connected to the energy-harvesting device via a flexible electrical connecting line, then a high level of reliability can be provided even with comparatively high rotation speeds.

The energy-harvesting device can be provided with a reference potential if the energy-harvesting device has a ground line that is electrically connected to the ground of the electric motor via the rotor.

A reliable data transmission of measurement data can be enabled if the measuring device has a sensor and a wireless transmission device for transmitting sensor data of the sensor.

A field at the end turn that is sufficient for the energy supply can be produced if the electric motor has a motor control or motor regulator that controls or regulates the winding voltage of the stator winding by means of pulse-width modulation (PWM).

### BRIEF DESCRIPTION OF THE DRAWINGS

The subject matter of the invention is depicted in greater detail in the drawings based on one embodiment variant serving as an example. In the drawings:

FIG. 1 shows an axially cutaway view of a partially depicted electric motor,

FIG. 2 shows a cross-sectional view at II-II through a conductor support of an energy-harvesting device of the electric motor from FIG. 1,

FIG. 3 is a three-dimensional view of the conductor support from FIG. 2 with one electrode,

FIG. 3a is a three-dimensional view of the conductor support from FIG. 2 with two electrodes,

FIG. 4 is a schematic circuit diagram with an energy-harvesting device of the synchronous machine shown in FIG. 1, with one electrode for energy harvesting, and

FIG. 4a shows an energy harvesting of the energy-harvesting device that has been modified relative to FIG. 4, with two electrodes.

### DETAILED DESCRIPTION OF THE INVENTION

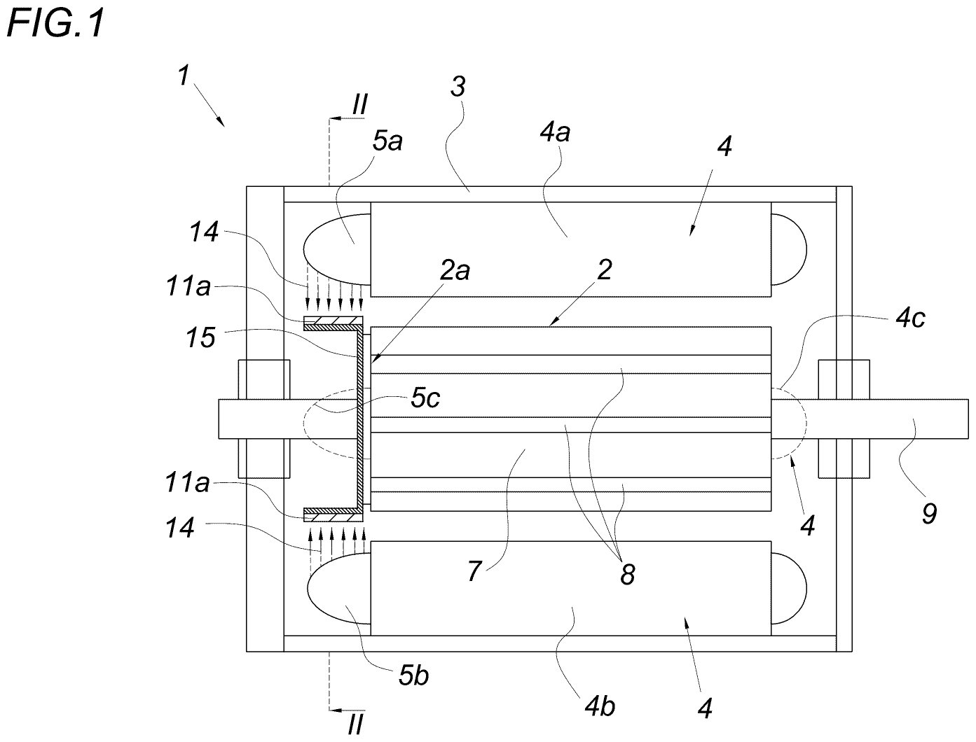

FIG. 1 shows a rotor 2 embodied as an internal rotor and a stator 3 of an electric motor 1, namely a permanent magnet-excited synchronous motor.

The stator 3 has a multi-phase stator winding 4 for producing a rotating stator field whose three coils 4a, 4b, 4c each form an end turn 5a, 5b, 5c at both ends 6a, 6b of the stator 3.

The rotor 2 has a rotor yoke 7 and permanent magnets 8 provided in recesses in the rotor yoke 7 and the rotor yoke 7, which consists of a lamination stack, is fastened to a drive shaft 9.

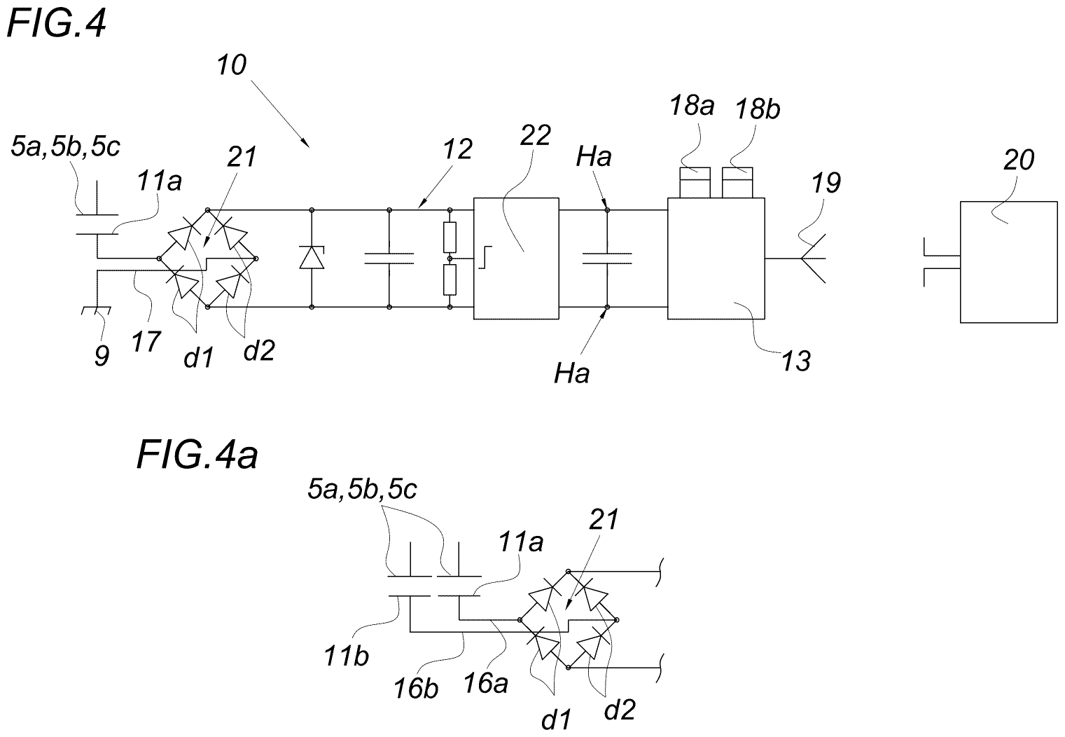

The electric motor 1 also has an energy-harvesting device 10 with an electrode 11a and an electrical circuit 12 that is connected to the electrode 11a as shown in FIG. 4. Using the electrode 11a, the energy-harvesting device 10 draws electrical energy from the electrical field 14, which forms as a counter electrode between the electrode 11a and the end turn 5 of the stator winding 4, in order to supply electrical power to a measuring device 13. This measuring device 13 is connected to the electrical outputs Ha of the energy-harvesting device 10, i.e. is connected to the latter.

The energy-harvesting device 10 and the measuring device 13 are provided on the rotor 2. In order to be able to draw electrical energy despite the fact that the rotor 2 rotates synchronously along with the rotating field, the electrode 11a extends essentially all the way around in the circumference direction U of the rotor 2, as is shown in FIG. 3. In addition, the electrode 11a is positioned in the axial extension of the rotor 7 and is positioned next to the end surface 2a of the rotor 2. It extends away from the end surface 2a of the rotor 2 in the axial direction. In the exemplary embodiment, the electrode 11a protrudes axially from the rotor yoke 7 to at most the level of the free end of the end turn 5.

In addition, the electrode 11a is provided protruding radially from the rotor 2 in order to position this electrode 11a close to the end turn 5 and thus to maximize the electrical field 14.

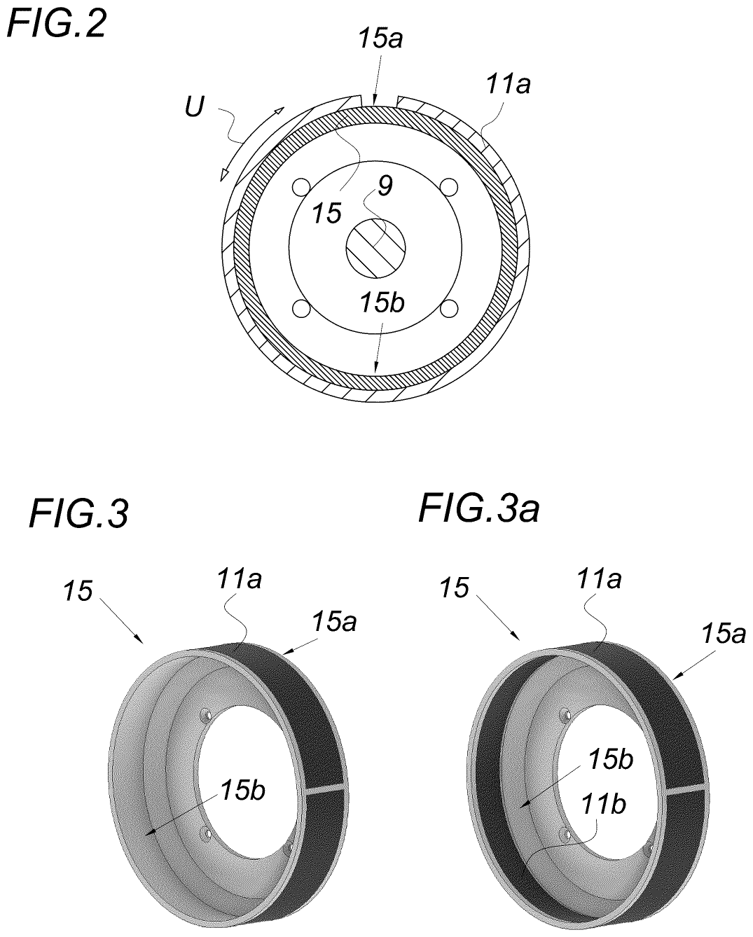

The electrode 11a is embodied by a conductor that extends in a ribbon shape, as can be seen in FIG. 2 and FIG. 3.

In a simple design solution, the electrode 11a is fastened to the rotor 2, specifically to the rotor yoke 7, with the aid of a conductor support 15 made of plastic. In the exemplary embodiment, this conductor support 15 adjoins the end surface of the rotor yoke 7 and supports the first electrode 11a on its outside 15a, as shown in FIGS. 2 and 3.

The conductor support 15 also has a hollow cylindrical section, which is circular in cross-section. It is thus possible to provide the second electrode 11b of the electrodes 11a, 11b on an inside 15b of the conductor support 15, as can be seen in FIG. 3a.

The two electrodes 11a, 11b are thus provided opposite each other on the outside 15a and inside 15b of the conductor support 15. The electrodes 11a, 11b are printed onto the conductor support 15.

The energy-harvesting device 10 is connected to the first and second electrode 11a, 11b with a flexible electrical connector cable 16a, 16b.

The electrode 11a of the conductor support 15 is connected to a rectifier 21, namely a full wave rectifier (two-pulse bridge rectifier circuit B2), specifically with a first AC voltage input between the first diode pair d1.

The energy-harvesting device 10 also has a ground line 17 that is connected via the output shaft 9 to the ground of the electric motor 1, as schematically depicted in FIG. 4. This ground is connected to another second AC voltage input between the second diode pair d2 of the rectifier 12.

If two electrodes 11a, 11b are used for the “energy harvesting”, then—as shown in FIG. 4a—the second electrode 11b (instead of being connected to ground as shown in FIG. 4) is connected via the connector cable 16b to the second AC voltage input between the second diode pair d2.

The measuring device 13 that is supplied with electrical energy with the aid of the energy-harvesting device 10 has several temperature sensors 18a, 18b, whose measurement data are transmitted via a wireless transceiver device 19, for example through the use of a Bluetooth technology.

For example, these measurement data are transmitted to a motor control or motor regulator 20 of the electric motor 1. These physical measurement data can, for example, be taken into account by the motor control or motor regulator 20, for example in the control/regulation of the winding voltage of the stator winding 4 by means of pulse-width modulation (PWM).

The capacitance that forms between the electrode 11a and the end turn 5a, 5b, 5c can reach several pF. The AC voltage signal produced at the stator winding 4 with the aid of pulse-width modulation (PWM) more particularly has high-frequency components, which are produced through a switching of the inverter. These high-frequency components dominantly couple into the electrode 11a and result in a current flow at the rotor-side rectifier 21 of the energy-harvesting device 10. This produces a sufficiently high output voltage at the rectifier 21, which is regulated to a desired level at the output Ha by the DC-DC converter 22 of the energy-harvesting device 10 for supplying electrical energy to the measuring device 13.

1. An electric motor, comprising:
a stator that has an electrical stator winding for producing a rotating stator field, wherein said electrical stator winding has at least one end turn;
a rotor;
an energy-harvesting device that draws energy from the at least one end turn of the electrical stator winding; and
a measuring device that is connected to the energy-harvesting device in order to be supplied with electrical energy, wherein the energy-harvesting device and the measuring device are provided on the rotor, and the energy-harvesting device has at least one electrode for drawing electrical energy from an electrical field that forms as a counter electrode between the at least one electrode and the at least one end turn, and the at least one electrode extends in a circumference direction of the rotor and is positioned next to an end surface of the rotor.

2. The electric motor according to claim 1, wherein the at least one electrode is formed by a conductor, which extends in a ribbon shape.

3. The electric motor according to claim 1, wherein the at least one electrode protrudes radially from the rotor.

4. The electric motor according to claim 1, wherein the rotor has a rotor yoke and a conductor support, which is fastened to the rotor yoke and supports the at least one electrode.

5. The electric motor according to claim 4, wherein the conductor support has a section in the form of a circular ring in cross-section on which the at least one electrode is provided.

6. The electric motor according to claim 4, wherein the conductor support consists of plastic onto which the at least one electrode is printed.

7. The electric motor according to claim 4, wherein a first electrode of the at least one electrode is provided on an outside of the conductor support and/or a second electrode of the at least one electrode is provided on an inside of the conductor support.

8. The electric motor according to claim 4, wherein the at least one electrode provided on the conductor support is connected to the energy-harvesting device via a flexible electrical connecting line.

9. The electric motor according to claim 1, wherein the energy-harvesting device has a ground line that is electrically connected to a ground of the electric motor via the rotor.

10. The electric motor according to claim 1, wherein the measuring device has a sensor and a wireless transmission device for transmitting sensor data of the sensor.

11. The electric motor according to claim 1, wherein the electric motor has a motor control or motor regulator that controls or regulates a winding voltage of the electrical stator winding by means of using pulse-width modulation (PWM).

12. The electric motor according to claim 1, wherein the electric motor is a permanent magnet-excited synchronous motor.

13. The electric motor according to claim 4, wherein the conductor support is an electrically insulating conductor support.

14. The electric motor according to claim 4, wherein the conductor support adjoins the rotor yoke.

15. The electric motor according to claim 5, wherein the section of the conductor support that is in the form of a circular ring in cross-section is a hollow cylinder.
